(19) United States
(12) Patent Application Publication
(10) Pub. No.: US 2025/0038544 A1
(43) Pub. Date: Jan. 30, 2025

(54) METHOD AND SYSTEM FOR PERFORMING LOAD CONTROL ON THE POWER CONSUMPTION OF A FLEET OF ELECTRIC TRANSPORT VEHICLES

(71) Applicant: Faiveley Transport Tours, Saint-Pierre-Des-Corps (FR)

(72) Inventor: Philippe AUBIN, Paris (FR)

(73) Assignee: Faiveley Transport Tours, Saint-Pierre-Des-Corps (FR)

(21) Appl. No.: 18/709,447

(22) PCT Filed: Nov. 8, 2022
(86) PCT No.: PCT/EP2022/081148

§ 371 Date: May 10, 2024

(30) Foreign Application Priority Data
Nov. 10, 2021 (FR) FR2111937

(51) Int. Cl. H02J 4/00; B60H 1/00

(52) U.S. Cl. CPC H02J 4/00; B60H 1/00428; H02J 2310/48; H02J 2310/52; H02J 2310/54; H02J 2310/60

(57) ABSTRACT

The invention relates to a method for shedding, during a predefined period of time, the electricity consumption of a fleet (420) of electric transport vehicles supplied by an electricity network, the fleet (420) comprising at least one active electric transport vehicle (420a, 420b) in operation, and each electric transport vehicle (420a, 420b, 420c, 420d) comprising an air conditioning system (460) designed to modify a temperature of an interior of the electric transport vehicle;

the method comprising, during the predefined period of time:
acquiring a difference between a reference frequency and a frequency of a voltage supplied by the electricity network;
modifying the electricity consumption of the air conditioning system (460) of said at least one active vehicle (420a, 420b) as a function of said difference.

### TECHNICAL FIELD OF THE INVENTION

The present invention relates to a method for shedding electricity consumption of a fleet of electric transport vehicles. The present invention also relates to a system designed and configured to carry out such a method.

The invention can be applied in particular to fleets of rail transport vehicles, for example trains, underground trains, trams, trolleybuses, etc., supplied by an electricity network.

### PRIOR ART

The electrical energy produced by energy production centres should ideally be equal to the electrical energy consumed by all electricity consumers.

In order to achieve this objective, energy consumption predictions are made, for example on a daily basis, in particular for major electricity consumers such as the transport sector, the steel industry, etc. Based on the predictions, the production of electrical energy by the energy production centres as well as the management of consumption deviations in relation to the expected consumption are planned by the electricity network management company.

In this way, the electricity network management company responsible for balancing electricity supply and demand identifies situations where electricity consumption is not in line with electricity production. For example, the management company is able to:
identify one or more peak periods when consumption exceeds electricity production, or a situation where electricity consumption is slightly higher than electricity production, which would result in the unnecessary start-up of an additional production unit;
identify a situation where electricity consumption is slightly lower than electricity production, which is not acceptable in terms of optimising electricity production.

According to the identified situations, the management company establishes a shedding strategy. This strategy involves temporarily reducing or increasing electricity consumption in one or more periods of time ranging from a few seconds to 30 minutes for example in order to restore the balance between electricity production and consumption.

This strategy relies on balancing reserves that can inject electrical energy into the electricity network and/or offload electrical energy from the network, i.e. withdraw electrical energy from the network.

These balancing reserves can be supplied by balancing participants who communicate with the management company, such as electrical energy producers, electrical energy consumers or any other player able to inject or withdraw electrical energy from the network.

In this way, in response to a shedding order reflecting directives issued by the management company, balancing participants are invited to modify their electricity consumption.

Nowadays, passenger transport, and in particular rail transport, is one of the biggest electricity consumers in France. In a passenger transport vehicle, such as a rail vehicle, the air conditioning system is the equipment that consumes the most amount of electrical energy after the traction system of the vehicle.

The aim of the invention is to propose a technical solution making it possible to use a fleet of electric transport vehicles as a balancing participant, by precisely varying the electricity consumption of the fleet, in particular the air conditioning system, according to the fluctuation in the consumption of the energy supplied by the electricity network in relation to the fluctuation in the consumption of the electricity supplied by the electricity network.

### DISCLOSURE OF THE INVENTION

In this regard, the present invention relates to a method for shedding, during a predefined period of time, the electricity consumption of a fleet of electric transport vehicles supplied by an electricity network, the fleet comprising at least one active electric transport vehicle in operation, and each electric transport vehicle comprising an air conditioning system designed to modify a temperature of an interior of the electric transport vehicle;

the method comprising, during the predefined period of time:
acquiring a difference between a reference frequency and a frequency of a voltage supplied by the electricity network;
modifying the electricity consumption of the air conditioning system of said at least one active vehicle as a function of said difference.

Such a method makes it possible, when an increase or a decrease in the electricity consumption is effectively detected, by means of measuring the frequency of the electricity network supplying the fleet of vehicles, to respectively reduce or increase the electricity consumption of a fleet of electric transport vehicles to maintain the balance between the energy supplied by the network and the energy consumed from the network.

Such a method thus enables the primary shedding of the electricity consumption of a fleet of vehicles.

In addition, modifying the electricity consumption of the air conditioning system comprises sending a command to modify the consumption of the air conditioning system during the predefined time period, the modification command comprising:
sending a first correction value to modify the power supply to the air conditioning system of said at least one active vehicle during a first time period; and/or
sending a second correction value to modify the temperature of the interior of the active vehicle during a second time period;
wherein the second time period is greater than the first time period, and
wherein the first and/or second correction values are determined based on the acquired difference.

The method thus enables a dual action on the electricity consumption of the air conditioning system.

A so-called quick action reduces or increases, in a short time, the consumption of the air conditioning system, by modulating the power supply to the air conditioning system. This enables the electrical power supplied by the electricity network to be increased or decreased quickly.

A so-called slow action reduces, over a longer period of time, the consumption of the air conditioning system, by reducing or increasing the consumption of the air conditioning system over a second period, by modifying in particular the temperature at which the interior of the vehicle is kept.

The first time period can be less than 30 seconds. The second time period can be greater than 30 seconds and less than or equal to 30 minutes.

Acquiring the difference between a reference frequency and a frequency of a voltage supplied by the electricity network can comprise:
determining a type of supply voltage for the vehicles in the fleet;
if the supply voltage for the vehicles is DC, determining harmonics of the supply voltage to deduce therefrom the frequency of the voltage supplied by the electricity network;
if the supply voltage for the vehicles is AC, measuring the frequency of the supply voltage to deduce therefrom the frequency of the voltage supplied by the electricity network.

Acquiring the difference between a reference frequency and a frequency of a voltage supplied by the electricity network can comprise:
receiving the frequency of the voltage supplied by the electricity network.

Such a method is thus designed to enable shedding, whatever the nature of the voltage supplied by the electric vehicle power supply network. In this way, whether the voltage is direct current or AC, the method is designed to determine the frequency of the electricity network, whatever the nature of the supply voltage supplied to the vehicles in the fleet by the electricity supply network.

The reference frequency can be comprised in the range [48 Hz;52 Hz].

The method can also comprise during the predefined period of time:
periodically sending the consumption of the air conditioning system.

Such a method makes it possible to check that the shedding request has been carried out correctly during the predefined time period. This makes it possible to send the decrease or increase in consumption of the air conditioning system to the management company in real time, for example.

The method can also comprise:
receiving geographic information defining a geographic area for shedding;
determining the location of the vehicle in relation to the geographic area for shedding;
   during the predefined time period, the method also comprising the acquisition and modification steps when the vehicle is located in the geographic area for shedding.

The invention also relates to a system for shedding the electricity consumption of a fleet of electric transport vehicles supplied by an electricity network, the system comprising at least one device for acquiring a frequency of a voltage supplied by the electricity network,
the electric transport vehicles in the fleet comprising:
an air conditioning system designed to modify a temperature of an interior of the electric transport vehicle; and
a control unit configured to control the air conditioning system and receive a signal from the acquisition device;
wherein the control unit is configured to:
   acquire a difference between a reference frequency and a frequency of a voltage supplied by the electricity network by means of the acquisition device;
   modify the consumption of the air conditioning system of said at least one active vehicle as a function of said difference.

Such a system can in particular be used for primary consumption shedding by a fleet of electric transport vehicles. Indeed, by detecting a situation of imbalance between the voltage supplied by the electricity network and the voltage consumed by the electricity network, the system can modulate the consumption of the air conditioning system of the various active electric transport vehicles in the fleet.

The vehicles in the fleet can each comprise a device for measuring the frequency of the voltage supplied by the electricity network.

This thus enables quick primary consumption shedding and does not require data to be exchanged with a remote server.

The device for measuring the frequency can be configured to determine a type of supply voltage for the vehicles in the fleet, the device for measuring the frequency comprises:
a first sub-module configured to determine harmonics of the direct current supply voltage to deduce therefrom the frequency of the voltage supplied by the electricity network;
a second sub-module configured to measure the frequency of the alternative current supply voltage to deduce therefrom the frequency of the voltage supplied by the electricity network.

The electric transport vehicles also comprise an energy management module including means for connection to a temperature control system and to a temperature sensor,
the control system being associated with an air conditioning system and being configured to maintain the temperature of an interior at a set temperature as a function of a temperature measured by the temperature sensor corresponding to the interior temperature,
   said energy management module also including temperature shifting means designed to shift said temperature measured by the temperature sensor by a predetermined value,
the control unit being configured to send the second correction value to the temperature shifting means to shift the measured temperature.

Such a shedding system makes the method compatible with existing vehicles, the energy management module can in particular be used to vary the consumption of the air conditioning system by luring the temperature sensor. This therefore makes the solution generic such that the energy management module, which can be interfaced with various types of vehicles, is used to reduce the energy consumption of the air conditioning system following confirmation of the shedding request.

In the shedding system, the vehicles can also comprise:
a solid-state relay, configured to be actuated by the control unit, designed to modify the power supply to the air conditioning system;
the control unit being configured to send a first correction value to the solid-state relay to modify the power supply to the air conditioning system.

In the shedding system, the vehicles can also comprise:
a contactor connecting the air conditioning system to the power supply network, the contactor comprising a coil by means of which the power supply to the air conditioning system from the electricity network is modulated,
the control unit being configured to send a first correction value to the contactor to modify, by means of the coil, the power supply to the air conditioning system.

Other specific features and advantages of the invention will also become apparent in the following description.

### BRIEF DESCRIPTION OF THE FIGURES

The invention, according to one exemplary embodiment, will be better understood and its advantages will become more apparent upon reading the following detailed description, given by way of example and in no way limiting, with reference to the appended drawings wherein:

FIG. 1 is an exemplary chronology of the shedding actions;

FIG. 2 shows a shedding method;

FIG. 3 shows a system for shedding the consumption of a fleet of electric transport vehicles, designed to carry out the method described with reference to FIG. 2;

FIG. 4 shows a system for supervising the execution of a shedding request comprising the system shown in FIG. 2 for shedding in response to a shedding request from a management company; and

FIGS. 5A and 5B respectively show two embodiments of a sub-module of the module for measuring the frequency of the voltage supplied by the electricity network included in the system shown in FIG. 3.

### DETAILED DESCRIPTION

Identical elements shown in the aforementioned figures bear identical reference numbers.

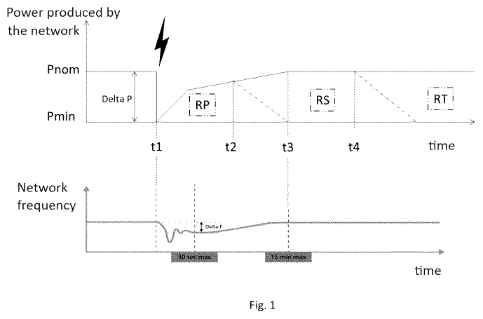

FIG. 1 shows an exemplary chronology of the shedding actions to restore the balance between electricity production and electricity consumption in a given electricity network.

In this example, the balance between electricity production and consumption is restored when an electricity producer suffers a failure, resulting in a reduction in the power produced following this interruption. The balance can in particular be restored in other circumstances, for example during consumption peaks.

FIG. 1 thus shows the power produced and the frequency of the network over time when the balance between electricity production and consumption is restored.

At the moment t1 when the electricity producer suffering a failure causes a reduction in the power delivered ΔP by the electricity network, the shedding mechanism is triggered. The reduction in delivered power causes the power produced by the electricity network to fall from the value Pₙₒₘ to the value Pₘᵢₙ.

The aim of the shedding mechanism is to recover from the reduction in power ΔP by means of balancing participants such as producers, consumers or any other player able to inject or withdraw electrical energy from the network. The balancing actors thus provide balancing reserves, which according to the instructions from the management company, enable the power provided by the electricity network to be restored.

The electricity injection or shedding reserves of balancing actors are classified, according to predefined specifications, as primary, secondary or tertiary reserves. Primary and secondary reserves are used to regulate the electrical power available from the network to compensate for reductions or increases in the electrical power supplied by the network. Tertiary reserves are used to modulate the electrical power available from the electricity network in response to a request from the management company. In particular, in order to be classified in one of the classes, injection or shedding reserves have to meet specific conditions relating to the speed of injection or shedding.

For example, in the case of injection in France, reserves have to meet the following conditions:
For primary reserves, restore at least some of the missing power within 30 seconds of detecting a power shortage;
For secondary reserves, fully restore the missing power after the action of the primary reserve on the missing power, over a maximum of 15 minutes following detection of the power shortage;
For tertiary reserves, permanently replace the missing power after the actions of the primary and secondary reserves, following detection of the power shortage.

In the case of shedding, the time conditions are applied to shed the additional power after the action of the primary, secondary and tertiary reserves.

Of course, the timescales within which the primary, secondary and tertiary reserves restore the missing power can vary depending on the geographic areas.

In this way, as shown in FIG. 1, during a first phase of the shedding mechanism, between the moments t1 and t2, the balancing participant or participants, providing a first reserve, reduce(s) their consumption in order to provide power that partially compensates for the reduction in power ΔP within a few seconds, for example 30 seconds from the shedding mechanism being triggered. In this way, at the moment t2, the power of the electricity network is restored to a level just below Pₙₒₘ before the failure of the electricity producer.

During the second phase, between the moments t2 and t4, the balancing participant or participants supplying secondary reserves take(s) over in order to progressively supply, taking into account the reduction in electrical power supplied by the primary reserve(s), electrical power to restore the power supplied by the electricity network at moment t3 to the same level Pₙₒₘ as before the failure of the electricity producer.

During the third phase, from the moment t4, the balancing participant or participants supplying tertiary reserves take(s) over in order to progressively supply, according to the reduction in electrical power supplied by the secondary reserve(s), electrical power to maintain the power supplied by the electricity network at the same level Pₙₒₘ as before the failure of the electricity producer.

As can be seen in the time trend of the frequency and voltage supplied by the electricity network, the reduction in power produced is characterised by a variation in the frequency of the voltage supplied.

Indeed, in nominal operating conditions, when the power consumed and the power produced distributed by the electricity network are in balance, the frequency of the voltage supplied by the electricity network is substantially stable, and substantially equal to a reference frequency. The value of the reference frequency of the supplied voltage depends on the geographical location of the electricity network. For example, in Europe, the frequency of the voltage supplied by the network can vary between 48 and 52 Hz, such that the reference frequency can be selected within this range of values. For example, the reference frequency can be equal to 50 Hz.

In this way, a reduction in the power produced results in a reduction in the frequency of the voltage supplied by the electricity network as shown in FIG. 1.

Generally speaking, when there is an imbalance between the power produced, i.e. the power supplied by the electricity network, and the power consumed, this results in variations in the frequency and voltage supplied by the electricity network. In this way, when the power produced is greater than the power consumed, the frequency of the voltage supplied by the electricity network increases and vice versa.

As mentioned above, a large proportion of the energy consumed by electric transport vehicles is used to power an air conditioning system. The aim of the invention is to provide a method and system for modifying the electricity consumption of an electric transport vehicle to turn a fleet of electric vehicles into a balancing participant.

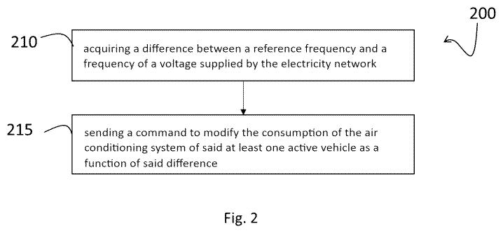

FIG. 2 shows a flowchart of a method for shedding the electricity consumption as primary or secondary reserve of a fleet of electric transport vehicles supplied by an electricity network.

The shedding is a variation in the electrical power consumed by balancing participants. As set out above, this variation is an increase or decrease in the consumption.

The method is carried out for a fleet of electric transport vehicles comprising at least one active vehicle.

An active vehicle is a vehicle in operation in which the air conditioning system is working. It is not simply a vehicle that is powered up, or being prepared for service, but a vehicle being used in which the air conditioning system is being used.

In the rest of the description, reference is made to an air conditioning system configured to heat or cool an interior, i.e. designed to modify the temperature of the interior of a vehicle. The air conditioning system can also be referred to as a heating, ventilation and air conditioning (HVAC) system.

Of course, the description is also applicable to an air conditioning system configured to heat or cool several interiors.

The air conditioning system can include an installation to heat the interior and an installation to cool the interior, or include a single installation to heat or cool the interior.

The method 200 comprises a first step 210, in which a difference between a reference frequency and a frequency of a voltage supplied by the electricity network is acquired.

For this, the frequency of the voltage supplied by the electricity network is acquired. The frequency of the voltage supplied by the electricity network can be acquired by means of a measurement. Alternatively, the frequency of the voltage supplied by the electricity network can be acquired by receiving the frequency of a voltage supplied by the electricity network: the measurement can be sent by a remote device, for example.

The second step 215 of the method 200 involves sending a command to modify the consumption of the air conditioning system of said at least one active vehicle as a function of said difference.

As shown with reference to FIG. 1, the imbalance between the electrical power consumed and the electrical power produced supplying the electricity network can be identified by variation in the frequency of the voltage supplied by the electricity network.

In this way, the second step involves detecting a variation in the frequency of the voltage supplied by the electricity network in relation to the reference frequency.

This detection can in particular be used to confirm that there is indeed an imbalance between the electrical power consumed and the electrical power produced supplying the electricity network.

As shown in FIG. 1, a reduction in the frequency below the reference frequency reflects an imbalance in which the electrical power consumed is greater than the electrical power produced supplying the electricity network.

An increase in the frequency above the reference frequency therefore reflects an imbalance in which the electrical power consumed is lower than the electrical power produced supplying the electricity network.

Likewise, an imbalance is identified depending on the sign of the difference between the reference frequency and the frequency of a voltage supplied by the electricity network: for example, the sign indicates in particular if the electrical power consumed is less than the electrical power produced supplying the electricity network or vice versa.

Depending on the value of the difference, the electricity consumption of the air conditioning system of the active transport vehicles is modified.

In this way, a command is sent to the air conditioning system of the active vehicles in the fleet. This is a command to modify the consumption of the air conditioning system, used in particular to modulate the electrical power supplying the air conditioning system.

Such a command to modify the consumption of the air conditioning system is used in particular to increase or reduce the consumption of the air conditioning system linearly and permanently.

The modification command is sent continuously and the amplitude of the modification command varies as a function of the difference determined.

The command to modify the consumption of the air conditioning system is thus used to modulate the power consumed by the air conditioning system over a predefined time range.

The command to modify the consumption of the air conditioning system can comprise a first and/or a second correction value.

The first correction value is a value to modify the power supply to the air conditioning system of said at least one active vehicle during a first time period. This value can, for example, be a duty cycle enabling the power supply to the air conditioning system to be modulated, by means of a solid-state relay for example.

The second correction value is a value to modify the temperature of the interior of the active vehicle during a second time period. This value can, for example, be a target temperature in degrees to which the air conditioning system has to heat the interior. For example, when the air conditioning system is configured to cool the interior, an increase in the target temperature to which the interior has to be cooled, makes it possible to reduce the electricity consumption of the air conditioning system. Similarly, when the air conditioning system is configured for heating, a reduction in the target temperature to which the interior has to be heated makes it possible to reduce the electricity consumption of the air conditioning system.

The result of applying the correction values is to modulate the power supply to the air conditioning system over a first time period and to reduce the power supply to the air conditioning system over a second time period, which is longer, i.e. greater, than the first time period.

The action of the first correction value is a so-called “quick” action because the power supply to the air conditioning system is modulated as soon as the correction value is sent over a short period. The action of the first correction value can be a few seconds, for example less than or equal to 1 second.

The action of the second correction value is a so-called “slow” action because the reduction in the consumption of the air conditioning system, by modifying the target temperature of the interior, makes it possible to modify the consumption over a longer period. The action of the second correction value can be comprised between 30 seconds and 30 minutes.

The first and second correction values are determined based on the difference between the reference frequency and the frequency of a voltage supplied by the electricity network.

For example, the first and second correction values can be proportional to the value of the difference acquired between the reference frequency and the frequency of a voltage supplied by the electricity network. In this case, the shedding can be called primary shedding.

Alternatively, the first and second correction values can be proportional to the sum of the value of the difference between the reference frequency and the frequency of a voltage supplied by the electricity network and the time integral of this difference. In this case, the shedding can be called secondary shedding.

The first and second correction values can be expressed in KW/Hz.

In order to validate the effective reduction in the consumption of the air conditioning system, the process can comprise monitoring the consumption of the air conditioning system. For example, during the predefined period of time during which the shedding is carried out, the method can comprise periodically sending the power consumed by the air conditioning system. It can, for example, be sent to the management company or an intermediary in real time in order to enable monitoring of the consumption of the air conditioning system. The consumption of the air conditioning system can be sent periodically.

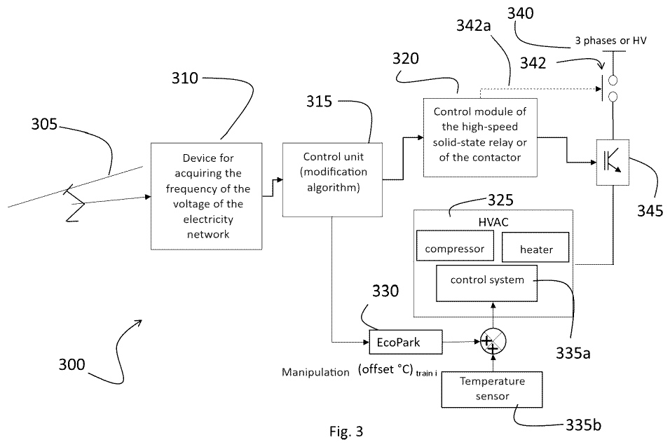

An exemplary shedding system 300 used according to the method described with reference to FIG. 2 is shown in FIG. 3.

The example shown of the shedding system 300 is an on-board system in one or more vehicles in the fleet of electric transport vehicles.

In this example, the shedding system 300 comprises a device 310 for acquiring the frequency of the voltage supplied by the electricity network 305.

Electric vehicles are powered by the electricity network by means a set of substations and the electrical supply network.

The supply substations and the electrical supply network are supplied by the electricity network. Each substation is configured to supply power to electric vehicles in a predetermined geographic area.

The supply voltage for vehicles can be either alternative current or direct current.

In the case of alternative current voltage, the frequency of the supply voltage is equal to the frequency of the voltage supplied by the electricity network. The amplitude of the alternative current voltage can be comprised between 1500V and 25000V.

In the case of direct current voltage, direct voltage is obtained at substation level by rectifying and filtering the alternative current voltage supplied by the electricity network. The direct current voltage amplitude can be comprised between 600 V and 5000 V, for example 1500 V.

Vehicles can be powered by means of a pantograph when the power supply network is an overhead line. Alternatively, vehicles can be powered by means of a collector shoe when the power supply network is a third rail.

The acquisition device 310 can comprise a measurement module designed to periodically or continuously measure the frequency of the voltage supplied by the electricity network supplying the fleet of electric transport vehicles. The measurement module can be arranged so as to measure the frequency of the voltage supplied by the electricity network 305 at a contact point.

This contact point can be on the pantograph of the vehicle or on the collector shoe.

The contact point can also be at a supply substation or any point of the power supply network.

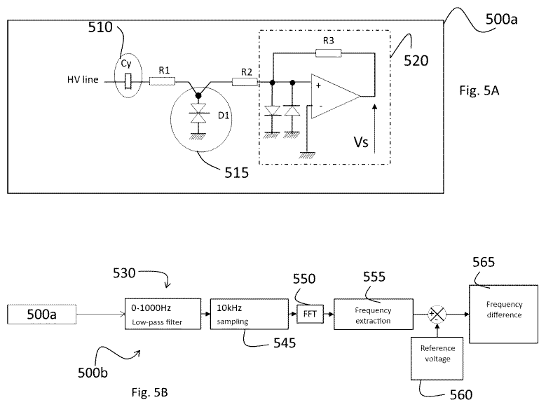

Given that the electrical supply voltage supplied by the substations can be either direct current or alternative current voltage, the measurement module can comprise at least two sub-modules:
A first sub-module configured to measure the frequency of the alternative current voltage supplying the electric vehicles which is the frequency of the electrical voltage supplied by the electricity network.
A second sub-module configured to determine harmonics of the direct current supply voltage to deduce therefrom the frequency of the voltage supplied by the electricity network. Examples are shown in more detail in FIGS. 5A and 5B.

For example, the measurement module can be arranged in each vehicle to measure the voltage supplied by the third rail or by the overhead line, at the collector shoe or pantograph respectively.

For example, the measurement module can be arranged at a substation or any other point of the power supply network where the voltage and frequency can be measured. In this case, the acquisition device 310 can comprise one or more communication modules designed to send and/or receive measurements of the frequency of the voltage supplied by the electricity network 305.

In other words, the frequency measured by the measurement module at a substation or any other point of the power supply network is sent by means of a communication module to the vehicles, which also comprise a communication module.

Such communication modules can, for example, enable data to be transmitted over a wireless network, can be for example a radio module compatible with WiFi, 5G or 4G networks.

The shedding system 300 comprises an air conditioning system 325 designed to modify the temperature of the interior of the vehicle in which the shedding system 300 is installed.

This air conditioning system, which is designed to either increase or reduce the temperature of the interior of a vehicle, can thus comprise heating means 325b and a compressor 325a. The heating means 325b are configured to heat the air to increase the temperature of the interior. The compressor 325a is configured to cool the air and reduce the temperature of the interior.

The shedding system 300 also comprises a control unit 315 configured to receive a signal from the acquisition device 310 and to control the air conditioning system 325 depending on the signal from the acquisition device 310.

The control unit 315 is configured to activate the shedding according to the measured value of the frequency of the voltage supplied by the electricity network acquired by the acquisition device.

The control unit 315 is thus configured to acquire the difference between the reference frequency and the frequency of a voltage supplied by the electricity network by means of the acquisition device 310.

Likewise, the control unit 315 is configured to send a command to modify the consumption of the air conditioning system of said at least one active vehicle as a function of said difference.

To do this, the control unit 315 is connected on the one hand to a solid-state relay 345 and on the other hand to an energy management module 330.

The solid-state relay control module 320 and the solid-state relay 345, which can be a high-speed solid-state relay, are used to modulate the power supply 340 to the air conditioning system. One exemplary high-speed solid-state relay 345 can, for example, be a transistor.

The energy management module 330 is a module used to reduce the electricity consumption of the air conditioning system.

The energy management module 330 can be used to modulate the electrical power consumed by the air conditioning system, i.e. increase or reduce the electrical power consumed by the air conditioning system as a function of the frequency of the voltage supplied by the electricity network. The energy management module can, for example, act by:
Modifying the power source for the air conditioning system for example in a vehicle in the fleet. Modules can in particular enable the air conditioning system to be powered for a predetermined period by on-board batteries;
Modifying the operation of the air conditioning system, for example to modify the target temperature, i.e. the actual temperature of the interior.

Moreover, an exemplary generic energy management module 330 that can be associated with any air conditioning system present in a transport vehicle is disclosed in the French patent application FR 3 011 912.

The proposed energy management module 330, also known as EcoPark, includes means for connection to a temperature control system 335a associated with an air conditioning system 325 and to a temperature sensor 335b.

The control system 335a is configured to maintain the temperature of an interior at a set temperature as a function of a temperature measured by the temperature sensor 335b corresponding to the interior temperature. In other words, the control system 335a is used to control the air conditioning system 325 in order to maintain a target temperature in the interior of the vehicle.

The energy management module 330 also includes temperature shifting means. These shifting means are used to modify the temperature measured by the temperature sensor 335b by a predetermined value: these shifting means are thus used to lure the temperature sensor 335b.

The energy management module 330 can be configured according to a first and second operating mode, when the vehicles in the fleet reduce their consumption and when the vehicles in the fleet increase their consumption.

In the first operating mode, with a view to reducing the electricity consumption, the shifting means of the energy management module 330 are configured to increase the temperature measured by the temperature sensor 335b when the air conditioning system 325 is configured for heating and to reduce the temperature measured by the temperature sensor 335b when the air conditioning system 325 is configured for cooling.

In the second operating mode, the shifting means of the energy management module 330 are configured to increase the temperature measured by the temperature sensor 335b when the air conditioning system 325 is configured for cooling and to decrease the temperature measured by the temperature sensor 335b when the air conditioning system 325 is configured for heating.

In this way, the control system 335a maintains the temperature of the interior at the set temperature as a function of the temperature measured by the temperature sensor 335b which has been shifted, i.e. increased or decreased by a predetermined value.

This increase or decrease amplifies at all times the difference between the set temperature and the temperature used as a reference for the control system, i.e. the offset temperature measured by the temperature sensor.

In this way, the control system 335a modulates an air conditioning system to heat or cool the interior until the offset temperature measured by the temperature sensor 335b decreases or increases respectively to a value close to the set temperature.

The electrical energy consumption is consequently modified.

In this way, the control unit 315 is configured to determine a shedding to carry out, expressed in KW/Hz, according to the difference between the reference frequency and the frequency of the voltage supplied by the electricity network. Then, based on the determined shedding, the control unit 315 is configured to determine a first and second correction value to respectively provide to the control module 320 of the solid-state relay 345 and to the energy management module 330 to reduce the consumption of the air conditioning system.

The first correction value provided to the control module of the solid-state relay 320 is used to quickly modify the power supply to the air conditioning system 325.

This first correction value can, for example, be a modification of the duty cycle ρ applied to the transistor 345 connecting the power supply network (power supply 340) to the air conditioning system 325. This duty cycle, representing the ratio between the transistor 345 being switched on and off, makes it possible to modify the power supply to the air conditioning system 325, reducing or increasing it according to the value of the duty cycle.

In particular, when the air conditioning system 325 is configured to heat the interior of the vehicle, the power supply to the heater is modulated. When the air conditioning system 325 is configured to cool the interior of the vehicle, the power supply to the compressor is modulated.

Modifying the duty cycle can increase or reduce the consumption of the air conditioning system 325 depending on the value used. The smaller the duty cycle, the more the electricity consumption of the air conditioning system 325 is reduced. By contrast, the greater the duty cycle, the more the electricity consumption of the air conditioning system 325 is increased.

The second correction value provided to the energy management module is used in particular to modify the consumption of the air conditioning system.

It can be a corrected target temperature or a command relative to the power source for the air conditioning system 325.

For example, in the case of an EcoPark energy management module, the second correction value can be the predetermined value, in degrees Celsius, used by the shifting means to modify the temperature measured by the temperature sensor.

The control unit 315 can thus be configured to send the second correction value to the temperature shifting means to shift the measured temperature.

The energy consumed by the air conditioning system is modified by the action of the energy management module over a longer period than the action of the contactor 342.

Some or all of the vehicles in a fleet can be fitted with a shedding system as described.

Alternatively, the power supply to the air conditioning system 325 can be modulated by a contactor 342, connecting the air conditioning system 325 to the power supply network 340.

This contactor 342, which can be an electromechanical controllable switch, can be controlled using a duty cycle. The contactor 342 can be activated (shown by the dotted arrow 342a by means of a control module 320 of the contactor 340) periodically, with periods of around 3 minutes for example.

The power supply to the air conditioning system can be modulated by this contactor 342 by modifying the control duty cycle.

The power supply to the air conditioning system can be modulated for example by modifying the duty cycle controlling a coil of the contactor 342, by delaying or advancing the control of the coil.

In this case, the first correction value can be the duty cycle enabling the power supply to the air conditioning system to be modulated by means of the contactor 342.

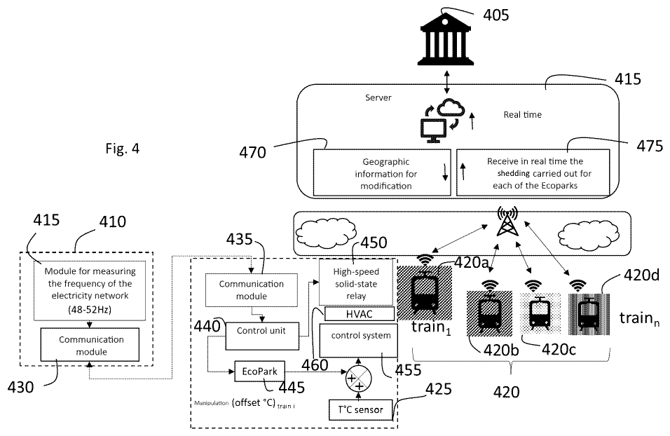

FIG. 4 shows an environment 400 in which an exemplary shedding system such as the one shown in FIG. 3 is used.

A fleet 420 of electric transport vehicles is shown. The vehicles in the fleet 420 are each fitted with a shedding system 425. For reasons of clarity, only one of the shedding systems 425 is shown.

In this fleet 420 of vehicles, only the vehicles 420a and 420b are active and can therefore carry out a shedding.

The vehicle 420d is being prepared for service and as it is not active cannot carry out a shedding by means of its shedding system 425. The same applies to the vehicle 420c which is inactive.

The vehicles in the fleet 420 are powered by a supply substation 410. A module for measuring the frequency of the electricity network 415, connected to a communication module 430, is arranged at this substation 410.

The communication module 430 is designed to transmit frequencies measured by the measurement module 415 to the communication module 435 of the shedding system 425 installed in the vehicles in the fleet 420.

The communication module 435 can also be designed to exchange data with a server 415, as shown in the figure.

The shedding system 425 also includes a control unit 440 which, depending on the frequency measurements received, modifies the consumption of the air conditioning system 460, by means of an energy management module associated with a temperature sensor 425 and the system 455 for controlling the air conditioning system, and by means of a high-speed solid-state relay.

The control unit 440 then determines correction values for each of the active vehicles, making it possible to vary the consumption of a vehicle in kilowatts (kW) over a given time period.

In one embodiment, it can be envisaged that each active vehicle regularly sends measurements of the electricity consumption of the air conditioning system 460 to the server 415. In this way, the server can be configured to transmit these measurements to a management company 405, which can then quantify the primary shedding carried out by the vehicle fleet 420.

Alternatively, the first and second correction values can be defined in relation to geographic information 470.

Consumption peaks and troughs can be observed in particular geographic areas. In this case, it makes sense to reduce the electricity consumption in the geographic areas affected, rather than reducing the electricity consumption in other more or less distant geographic areas.

The management company 405 can provide information relating to geographic locations where the balancing participants have to modify their electricity consumption.

For example, the management company 405 can provide such geographic indications in real time. Alternatively, the management company can provide this geographic information in advance the day before, based for example on the weather forecast and expected electricity consumption.

The geographic information can be provided by means of communication modules (not shown) present in the server 415 and/or at the management company 405. The server then sends this data to the vehicles in the fleet 420, which receive this data by means of communication modules (which can, for example, be the same as the communication module 435 or another separate communication module).

For example, when determining the correction values, only active vehicles located within a 10 km radius of the geographic area provided by the management company carry out a primary shedding.

The vehicles in the fleet can, for example, comprise a vehicle geolocation module, such as a GPS chip, connected to the control unit 440. The geographic information provided can, for example, be a set of GPS coordinates, defining a geographic area.

In this way, the control unit 440 can be configured to compare a location of a vehicle with the geographic information provided defining a geographic area for shedding. When the control unit 440 determines that the vehicle is in the geographic area, the correction values are determined to maximise shedding at this location. Otherwise, when the vehicle is outside of the geographic area provided by the management company, a lower or zero correction value is determined, i.e. the vehicle then carries out primary and/or secondary shedding of lesser magnitude or zero shedding.

FIGS. 5A and 5B show an exemplary sub-module of the measurement module, designed to determine the frequency of the voltage supplied by the electricity network comprised in the system shown in FIG. 3.

As mentioned, the voltage supplied to the electric transport vehicle, by means of the pantograph or third rail for example, can be an alternative current or direct current voltage.

If the supply voltage supplied to the electric transport vehicle is an alternative current voltage, the frequency is measured by known means, such as a frequency meter or any other known circuit for obtaining the frequency of the alternative current voltage supplied.

If the supply voltage supplied to the electric transport vehicle is a direct current voltage, i.e. resulting from the rectification and filtering of an alternative current voltage supplied by the electricity network, the frequency of the alternative current voltage supplied by the electricity network before being rectified is recovered.

Indeed, when the alternative current voltage supplied by the electricity network is rectified and filtered, for example at a substation, the direct current voltage obtained at the output contains a frequency linked to the rectification, this frequency being proportional to the frequency of the alternative current voltage supplied by the network.

For example, in the case of a three-phase alternative current voltage supplied by the network with a frequency of 50 Hz, at the output of a three-phase rectifier, the frequency at the output of the rectifier is six times the frequency of the alternative current voltage supplied by the electricity network, or 300 Hz. Thus, in this example, the direct current output voltage comprises rectification harmonics at a frequency of 300 Hz. To smooth the voltage, a bandpass filter is connected in series with the rectifier. As a result, only a low amplitude of the direct current output voltage remains which comprises rectification harmonics.

The sub-module shown in FIGS. 5A and 5B is a sub-module designed to determine the frequency of the voltage supplied by the electricity network when the supply voltage for the electric vehicles in the fleet is a direct current voltage.

The circuit shown enables the frequency of the direct current supply voltage, i.e. the rectification harmonic determined, to be used to determine the frequency of the alternative current voltage supplied by the electricity network.

The sub-module comprises a voltage and frequency sensor 500a and a processing module 500b.

The sensor 500a is directly connected to the high-voltage line 505, and is used to extract at the output the part of the direct current output voltage that comprises rectification harmonics.

An exemplary sensor 500a structure is shown in FIG. 5A.

The sensor 500a comprises a capacitor 510, which can preferably be a Y-type safety capacitor, suitable for high voltages, for example 15 kV.

The capacitor 510 is followed by a double transient voltage suppression diode 515 to protect the circuit from overvoltages.

In combination with a circuit 520 based on an operational amplifier, the capacitor can be used in particular to extract, and thus to obtain at the output Vs, part of the voltage comprising the rectification harmonics.

In this way, the frequency of the voltage supplied by the high-voltage electricity network 505 can be read by looking for the rectification harmonic at the output (Vs) of this circuit.

In this way, knowing the type of rectifier used, for example three-phase or six-phase or twelve-phase, it is possible to use the rectification harmonic to find the frequency of the alternative current voltage supplied by the electricity network.

Alternatively, it is possible to deduce the type of rectifier used by analysing the frequencies of the supply voltage. For example, if the supply voltage only comprises a frequency at 600 Hz, and not a frequency at 300 Hz, it is possible to deduce that a six-phase rectifier is being used.

For this, the digital circuit 500b is used, connected in series with the sensor 500a.

The voltage Vs obtained at the output of the sensor 500a is filtered by a low-pass filter 530 to remove high frequencies from the signal. All frequencies above 1000 Hz are preferably removed from the signal.

A sampling module 545 samples the signal in order to digitise it. Sampling can be carried out at a sampling frequency of around 10 kHz.

The harmonic frequencies contained in the digital signal at the output of the sampling module 545 are then determined by a module 550. To do this, the module 550 can carry out a digital Fast Fourier Transform or FFT in order to determine the harmonics making up the signal at the output of the sampling module 545.

Then, depending on the harmonics determined using the module 550, the frequency of the electricity network is extracted using the module 555. This module 555 can, for example, use a phase-locked loop or PLL in order to determine the main frequency of the harmonics determined.

The difference 565 with the reference frequency 550 can then be calculated as shown in FIG. 5B.

The advantage of such a circuit, in particular 500a at the sensor, is that it provides a dual level of fault tolerance.

Indeed, when a fault occurs at the capacitor 515, the circuit operates as an open circuit. Likewise, when a fault occurs at the double diode 515, the circuit operates as a short-circuit.

Although described through a certain number of detailed exemplary embodiments, the device and method proposed comprise various alternatives, modifications and improvements that will become apparent to a person skilled in the art, it being understood that these various alternatives, modifications and improvements fall within the scope of the invention, such as defined by the following claims.

In addition, various aspects and features described above may be implemented together, or separately, or substitute one another, and all of the various combinations and sub-combinations of the aspects and features fall within the scope of the invention.

Furthermore, it is possible that certain systems and equipment described above do not incorporate all of the modules and functions described for the preferred embodiments.

1. A method for shedding, during a predefined time period, an electricity consumption of a fleet of electric transport vehicles supplied by an electricity network, the fleet comprising an active electric transport vehicle in operation, and each electric transport vehicle comprising an air conditioning system designed to modify a temperature of an interior of the electric transport vehicle; the method comprising, during the predefined time period:
acquiring a difference between a reference frequency and a frequency of a voltage supplied by the electricity network;
modifying the electricity consumption of the air conditioning system of the active electric transport vehicle as a function of the difference; and
wherein modifying the electricity consumption of the air conditioning system comprises sending a modification command to modify the electricity consumption of the air conditioning system during the predefined time period, the modification command comprising:
sending a first correction value to modify a power supply to the air conditioning system of the active electric transport vehicle during a first time period; or
sending a second correction value to modify the temperature of the interior of the active electric transport vehicle during a second time period;
wherein the second time period is greater than the first time period, and
wherein the first correction value or the second correction value are determined based on the acquired difference.

2. The method of claim 1, wherein
the first time period is less than 30 seconds; and
the second time period is greater than 30 seconds and less than or equal to 30 minutes.

3. The method of claim 1, wherein acquiring the difference between the reference frequency and the frequency of the voltage supplied by the electricity network comprises:
determining a type of supply voltage for the electric transport vehicles in the fleet; and
if the type of supply voltage for the vehicles is DC, determining harmonics of the supply voltage to deduce therefrom the frequency of the voltage supplied by the electricity network; or
if the type of supply voltage for the vehicles is AC, measuring the frequency of the supply voltage to deduce therefrom the frequency of the voltage supplied by the electricity network.

4. The method of claim 1, wherein acquiring the difference between the reference frequency and the frequency of the voltage supplied by the electricity network comprises:
receiving the frequency of the voltage supplied by the electricity network.

5. The method of claim 1, wherein the reference frequency is in a range of 48 Hz to 52 Hz.

6. The method of claim 1, wherein, during the predefined time period the electricity consumption of the air conditioning system is periodically sent.

7. The method of claim 1, further comprising:
receiving geographic information defining a geographic area for shedding;
determining a location of the active electric transport vehicle in relation to the geographic area for shedding; and
during the predefined time period, the method also comprising the acquisition and modification steps when the active electric transport vehicle is located in the geographic area for shedding.

8. A system for shedding an electricity consumption of a fleet of electric transport vehicles supplied by an electricity network, the system comprising
a device for acquiring a frequency of a voltage supplied by the electricity network,
the electric transport vehicles in the fleet comprising:
an air conditioning system configured to modify a temperature of an interior of the electric transport vehicles; and
a control unit configured to control the air conditioning system and receive a signal from the acquisition device; wherein the control unit is configured to:
acquire a difference between a reference frequency and the frequency of the voltage supplied by the electricity network by means of the acquisition device; and
modify the electricity consumption of the air conditioning system of at least one electric transport vehicle as a function of the difference.

9. The system of claim 8, wherein the electric transport vehicles in the fleet each comprise a device for measuring the frequency of the voltage supplied by the electricity network.

10. The system of claim 9, wherein the device for measuring the frequency is configured to determine a type of supply voltage for the electric transport vehicles in the fleet, wherein the device for measuring the frequency comprises:
a first sub-module configured to determine harmonics of a direct current supply voltage to deduce therefrom the frequency of the voltage supplied by the electricity network; and
a second sub-module configured to measure a frequency of an alternative current supply voltage to deduce therefrom the frequency of the voltage supplied by the electricity network.

11. The system of claim 8, wherein the electric transport vehicles further comprise an energy management module including means for connection to a temperature control system and to a temperature sensor,
the temperature control system being associated with the air conditioning system and being configured to maintain the temperature of the interior at a set temperature as a function of a temperature measured by the temperature sensor corresponding to the temperature of the interior,
the energy management module also including a temperature shifting means designed to shift the temperature measured by the temperature sensor by a predetermined value, and
the control unit being configured to send a second correction value to the temperature shifting means to shift the measured temperature.

12. The system of claim 8, wherein the electric transport vehicles also comprise:
a solid-state relay configured to be actuated by the control unit, designed to modify a power supply to the air conditioning system; and
the control unit being configured to send a first correction value to the solid-state relay to modify the power supply to the air conditioning system.

13. The system of claim 8, wherein the electric transport vehicles also comprise:
a contactor connecting the air conditioning system to a power supply network, the contactor comprising a coil by means of which a power supply to the air conditioning system from the electricity network is modulated,
the control unit being configured to send a first correction value to the contactor to modify, by means of the coil, the power supply to the air conditioning system.

14. The system of claim 10, wherein the electric transport vehicles further comprise an energy management module including means for connection to a temperature control system and to a temperature sensor,
the temperature control system being associated with the air conditioning system and being configured to maintain the temperature of the interior at a set temperature as a function of a temperature measured by the temperature sensor corresponding to the temperature of the interior,
the energy management module also including a temperature shifting means designed to shift the temperature measured by the temperature sensor by a predetermined value, and
the control unit being configured to send a second correction value to the temperature shifting means to shift the measured temperature.

15. The system of claim 14, wherein the electric transport vehicles also comprise:
a solid-state relay configured to be actuated by the control unit, designed to modify a power supply to the air conditioning system; and
the control unit being configured to send a first correction value to the solid-state relay to modify the power supply to the air conditioning system.

16. The system of claim 14, wherein the electric transport vehicles also comprise:
a contactor connecting the air conditioning system to a power supply network, the contactor comprising a coil by means of which a power supply to the air conditioning system from the electricity network is modulated,
the control unit being configured to send a first correction value to the contactor to modify, by means of the coil, the power supply to the air conditioning system.

17. The method of claim 3, further comprising:
receiving geographic information defining a geographic area for shedding;
determining a location of the active electric transport vehicle-in relation to the geographic area for shedding; and
during the predefined time period, the method also comprising the acquisition and modification steps when the active electric transport vehicle is located in the geographic area for shedding.

18. The method of claim 4, further comprising:
receiving geographic information defining a geographic area for shedding;
determining a location of the active electric transport vehicle-in relation to the geographic area for shedding; and
during the predefined time period, the method also comprising the acquisition and modification steps when the active electric transport vehicle is located in the geographic area for shedding.
